(19) United States
(12) Patent Application Publication
(10) Pub. No.: US 2016/0277602 A1
(43) Pub. Date: Sep. 22, 2016

(54) INFORMATION PROCESSING APPARATUS, INFORMATION PROCESSING METHOD, AND INFORMATION PROCESSING SYSTEM

(71) Applicants: Hiroyuki IMAI, Kanagawa (JP); Mikiya ICHIKAWA, Kanagawa (JP)

(72) Inventors: Hiroyuki IMAI, Kanagawa (JP); Mikiya ICHIKAWA, Kanagawa (JP)

(73) Assignee: Ricoh Company, Ltd., Tokyo (JP)

(21) Appl. No.: 15/063,584

(22) Filed: Mar. 8, 2016

(30) Foreign Application Priority Data
Mar. 19, 2015 (JP) 2015-056036

(51) Int. Cl. H04N 1/00; G06F 3/12

(52) U.S. Cl. CPC H04N 1/00204; G06F 3/1207; G06F 3/1276; G06F 3/126; G06F 3/1285; H04N 2201/0094

(57) ABSTRACT

An information processing apparatus includes a memory that stores, for each of multiple printers, selection information associating at least one of a string, an image, and job information of a print job with printer identification information for identifying the printer being associated with terminal identification information for identifying an information processing terminal currently located near the printer, circuitry that selects, in response to a request for printing data, one of the multiple printers to print the requested data using the selection information stored in the memory, and further selects an information processing apparatus associated with the selected printer, a transmitter that transfers the a confirmation message requesting to confirm that the selected printer prints the requested data to the selected information processing terminal. The circuitry instructs the selected printer to print the requested data in response to receiving a confirmation response from the selected information processing terminal.

### CROSS-REFERENCE TO RELATED APPLICATIONS

This patent application is based on and claims priority pursuant to 35 U.S.C. §119(a) to Japanese Patent Application No. 2015-056036, filed on Mar. 19, 2015 in the Japan Patent Office, the entire disclosures of which are hereby incorporated by reference herein.

### BACKGROUND

1. Technical Field

The present invention relates to an information processing apparatus, an information processing method, and an information processing system.

2. Background Art

In printing systems that an information processing apparatus and multiple printers are connected via a network, a technology that automatically selects one of the printers in accordance with a content of print data or the information processing apparatus that requests to print is known. As a result, even if an inappropriate printer is specified by the information processing apparatus, an appropriate printer is reselected to print the print data.

### SUMMARY

An example embodiment of the present invention provides a novel information processing apparatus that includes a memory that stores, for each of multiple printers, selection information associating at least one of a string, an image, and job information of a print job with printer identification information for identifying the printer, the printer identification information of the printer being associated with terminal identification information for identifying an information processing terminal currently located near the printer, circuitry that selects, in response to a request for printing data, one of the multiple printers to print the requested data using the selection information stored in the memory, and further selects an information processing apparatus associated with the selected printer, a transmitter that transfers the a confirmation message requesting to confirm that the selected printer prints the requested data to the selected information processing terminal. The circuitry instructs the selected printer to print the requested data in response to receiving a confirmation response from the selected information processing terminal.

Further embodiments of the present invention provide an information processing method and an information processing system.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a configuration of a whole printing system as an embodiment of the present invention.

FIG. 2 is a diagram illustrating a hardware configuration of a personal computer (PC) included in the printing system as an embodiment of the present invention.

FIG. 3 is a diagram illustrating a software configuration of the PC as an embodiment of the present invention.

FIG. 4 is a diagram illustrating a printer selection list stored in the PC as an embodiment of the present invention.

FIG. 5 is a diagram illustrating a PC list stored in the PC as an embodiment of the present invention.

FIG. 6 is a diagram illustrating a displayed confirmation message as an embodiment of the present invention.

FIG. 7 is a diagram illustrating functional blocks included in the PC as an embodiment of the present invention.

FIG. 8 is a flowchart illustrating whole operation performed by the PC as an embodiment of the present invention.

FIG. 9 is a flowchart illustrating operation that checks a status of a printer as an embodiment of the present invention.

FIG. 10 is a diagram illustrating another configuration of the PC as an embodiment of the present invention.

FIG. 11 is a diagram illustrating a displayed confirmation request message as an embodiment of the present invention.

FIGS. 12A and 12B are diagrams illustrating a confirmation request list stored in the PC as an embodiment of the present invention.

FIG. 13 is a diagram illustrating a confirmation destination list stored in the PC as an embodiment of the present invention.

FIG. 14 is a flowchart illustrating operation performed by the PC in case of performing double check.

The accompanying drawings are intended to depict example embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the known technology, a person who requests to print is different from a person who receives a printout, it is possible to instruct a printer near to the person who receives the printout to print out. However, if the person who receives the printout does not notice that the printout is output, it is possible that the printout is left on the printer, causing a security problem.

In the embodiments described below, a system that can prevent the printouts from being left on the printer is provided.

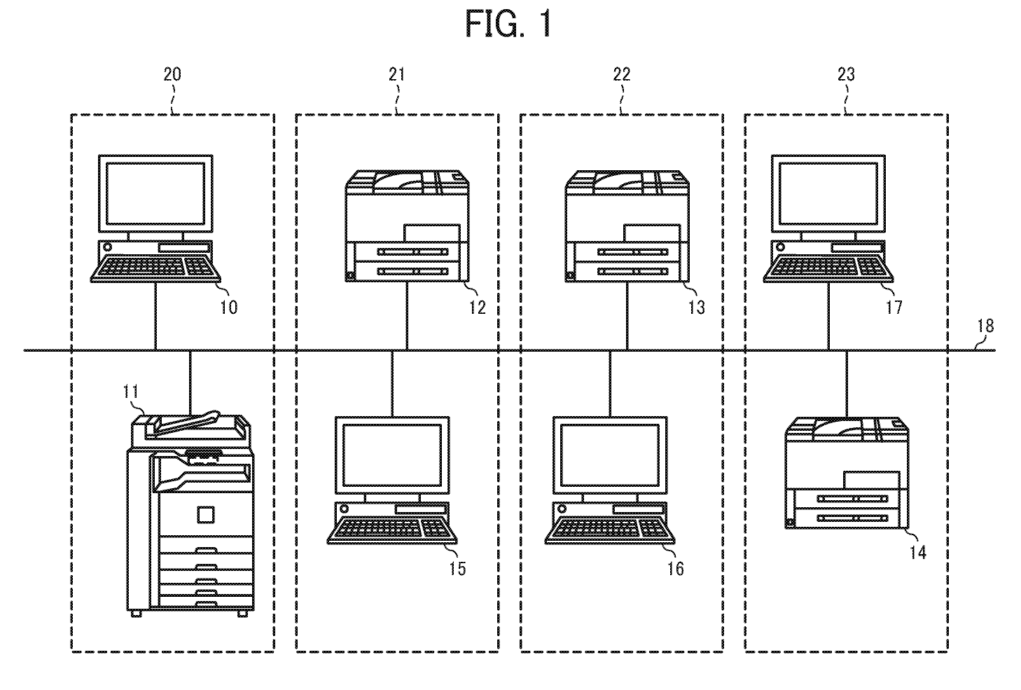

FIG. 1 is a diagram illustrating a configuration of a whole printing system in this embodiment. The printing system includes a PC 10 as an information processing apparatus operated by a user who requests to print and multiple printers 11 to 14 that the PC 10 transfers print data and instructs to print the print data. The printing system further includes PCs 15 to 17 as information processing terminals located in the vicinity of each of the printers 11 to 14. Those apparatuses are connected communicably with each other via a network 18.

In the description below, it is assumed that the printing system is constructed in a hospital, the PC 10 and the printer 11 are located in a consultation room 20 of a physician, and the PCs 15 to 17 and the printers 12 to 14 are located at hospital wards 21 to 23 where patients are accommodated. It should be noted that it is assumed that the hospital wards 21 to 23 are a bit far away from the consultation room 20.

If the physician instructs to print a prescription for a medicine for a patient hospitalized in the hospital ward 21, the PC 10 selects a printer among the printers 11 to 14 automatically and determines the printer 12 located at the hospital ward 21 where the patient is hospitalized. To select the printer automatically, for example, the PC 10 stores information on the patient and information on the printer located at the hospital ward where the patient is hospitalized associated with each other. In addition, the PC 10 stores information on the PCs 15 to 17 located in the vicinity of each of the printers 11 to 14. Using information on the PC 15 located in the vicinity of the determined printer 12, the PC 10 transfers a message requesting confirmation regarding printing a document using the printer 12 (confirmation message) to the PC 15.

The PC 15 displays the confirmation message including a confirmation button on its display. The PC 15 waits for an input until a nurse working at the hospital ward 21 notices the confirmation message. After the nurse notices the confirmation message and presses down the confirmation button, the PC 15 replies a response indicating that the message is confirmed to the PC 10.

After receiving the response indicating that the message is confirmed from the PC 15, the PC 10 instructs the printer 12 to print the prescription of the medicine. After receiving the instruction, the printer 12 prints out the prescription. As described above, since the prescription is printed out after the confirmation, it is possible to print out the prescription noticed by the nurse only and prevent the printout from being left on the printer.

The PCs 10 and 15 to 17 can be any one of a notebook PC, a desktop PC, and a tablet PC. A laser printer, an inkjet printer, and a multifunction peripheral (MFP) that includes multiple functions such as a print function, a scan function (a scanner function), a copy function, and a facsimile function etc. can be used for the printers 11 to 14. As shown in FIG. 1, the number of the PCs and the printers is not limited to four, and it can be two, three, or more than five.

It should be noted that the information processing terminals are not limited to the PCs 15 to 17, and it is possible to use any apparatus that includes a display and can respond by pressing a confirmation button as the information processing terminals. For example, an electronic whiteboard that includes a touch panel, a smartphone, the MFP, the printer, a copier, and a facsimile can be used as the information processing terminal.

The network 18 can be any one of a LAN, WAN and the Internet, and the network 18 can be either wired or wireless. In case of using a wireless network, it is possible to install an access point and perform communication via the access point. In addition, the printing system can include other apparatuses. For example, the printing system can include a print server etc. to control the printers 11 to 14.

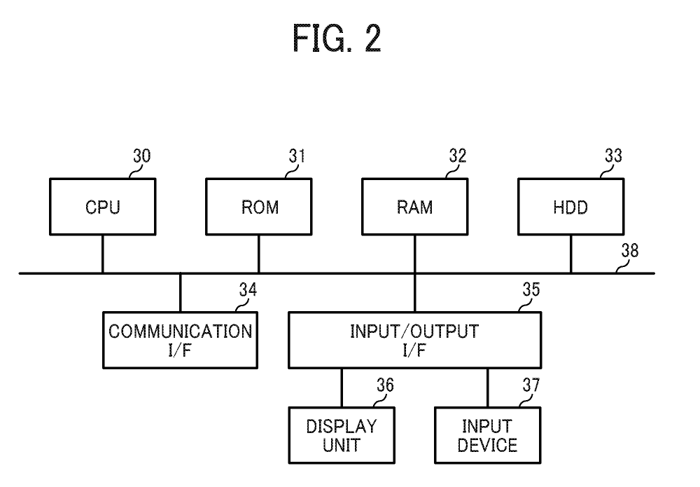

FIG. 2 is a diagram illustrating a hardware configuration of the PC 10 in this embodiment. Since the PCs 15 to 17 includes the configuration similar to the PC 10, the PC 10 only is described below. The PC 10 includes a CPU 30, a ROM 31, a RAM 32, a HDD 33, a communication interface (I/F) 34, an input/output I/F 35, a display unit 36, and an input device 37 as hardware components. The CPU 30, the ROM 31, the RAM 32, the HDD 33, the communication I/F 34, and the input/output I/F 35 are connected to a bus 38, and those components exchange data with each other via the bus 38.

The CPU 30 controls the whole PC 10. The ROM 31 stores a boot program to boot the PC 10 and firmware to control the display unit 36 and the input device 37 etc. The RAM 32 provides a work area used by the CPU 30 in executing various processes. The HDD 33 stores a program, an OS, and various data for executing the various processes described above.

The communication I/F 34 connects the PC 10 to the network 18 to enable to communicate with the printers 11 to 14 and the PCs 15 to 17 connected to the network 18. The input/output I/F 35 connects the display unit 36 and the input device 37 to input information and display a status of processing a job etc. A Cathode Ray Tube (CRT) and a liquid crystal display (LCD) can be used as the display unit 36. A mouse and a keyboard can be used as the input device 37.

Other than that, the PC 10 can include an external storage device I/F for a CD-ROM drive and a SD card slot etc., an audio input device such as a microphone, and an audio output device such as a speaker etc. The storage device is not limited to the HDD 33, and a Solid State Drive (SSD) etc. can be used as the storage device.

A hardware configuration of the printers 11 to 14 are not described in detail. For example, in case of electrophotographic printers, a photoconductor drum, an exposure unit, a charging unit, a developing unit, a transfer unit, and a fixing unit are included. In addition, the printers include a controller to control the whole printer. Under control of the controller, the charging unit charges the photoconductor drum, and the exposure unit irradiates the photoconductor drum with light to form a latent image on the photoconductor drum.

The developing unit attaches toner to a surface of the photoconductor drum to form a toner image, the transfer unit transfers the toner image to paper, and the fixing unit provides the paper to which the toner image is transferred heat and pressure to fix the toner on the paper.

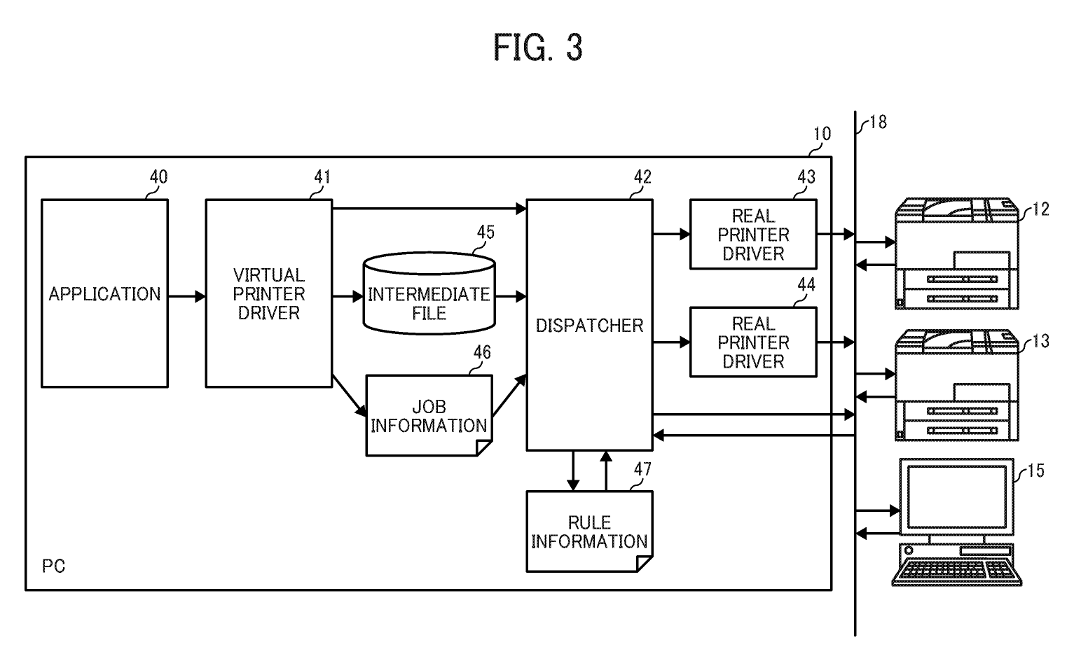

FIG. 3 is a diagram illustrating a software configuration of the PC 10 in this embodiment. Software that instructs the printers 11 to 14 to print, select one printer among the printers 11 to 14, and instructs the selected printer to print is implemented on the PC 10. In addition, software that transfers a confirmation message and receives a response to the confirmation message is implemented on the PC 10.

An application 40, a virtual printer driver 41, a dispatcher 42, and real printer drivers 43 and 44 are implemented on the PC 10 as software. The software is stored in a storage medium such as a CD-ROM, and it is possible to implement the software on the PC 10 by installing the software from the storage medium. The implementation of the software is not limited to that. It is also possible that a server connected to the network 18 stores the software, the PC 10 requests the server to download the software, and the software is implemented on the PC 10 by downloading the software from the server.

The application 40 provides a function that creates a document to be printed for the physician as the user. After the physician instructs the application 40 to print the document, the application 40 instructs the virtual printer driver 41 to print the document. The application 40 provides a screen to configure print settings for the physician and accepts information on the print settings. The application 40 transfers a request for printing including document data, information on the print settings, information on the PC 10, and information on the user who requested to print to the virtual printer driver 41.

After receiving the request for printing, the virtual printer driver 41 generates image data from the document data, extracts the information on the print settings, the information on the PC 10, and the information on the user, and generates an intermediate file 45 that consists of the extracted information and the image data. In addition, the virtual printer driver 41 considers the print of the document as one print job and generates job information 46. The virtual printer driver 41 requests the dispatcher 42 to determine a printer automatically.

Examples of the information on the print settings are the number of print sheets, print page, a paper size, a setting on color/monochrome, a setting on the number of printed pages allocated on one sheet, and a setting on duplex printing or not etc. Examples of the user information are a user name and a user ID etc. It should be noted that the user ID that the physician who uses the PC 10 inputs when the physician logs in the PC 10, the user name and the user ID preset in the PC as an administrator etc. can be used as the user information. Examples of the job information 46 are a document name to be printed, a status of a job, a creator of the document, the number of pages, and a size of data etc. Examples of the job statuses are waiting, printing, and an error etc.

After receiving the request from the virtual printer driver 41, the dispatcher 42 receives the intermediate file 45 and the job information 46 and determine a printer automatically. The dispatcher 42 determines a printer automatically in accordance with rule information 47 stored in the PC 10.

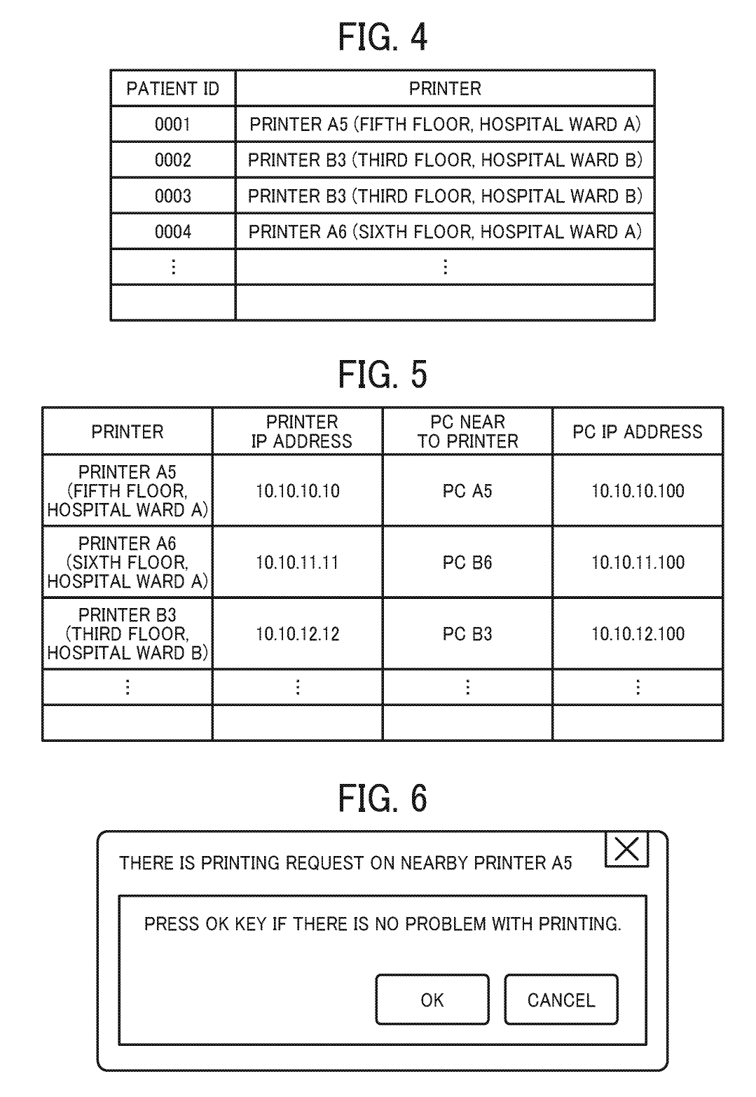

The rule information 47 includes selection information associating a keyword indicating a specified string or a specified image in the document or the job information 46 with identification information of printer to identify each printer. In FIG. 4, a table (a printer selection list) that associates a patient ID for identifying a patient as the keyword in the document with a printer name for identifying a printer and its positional information is illustrated as an example. By using the printer selection list, in accordance with the patient, it is possible to select a printer located at a hospital ward where the patient is hospitalized.

The keyword in the document is not limited to the patient ID, and it is possible to use a patient name and a patient address etc. as the keyword in the document. The job information includes the name of the document to be printed, and it is possible that the document name includes the patient ID and the patient name. As a result, it is also possible to obtain the patient ID and the patient name from the job information and select a printer from the printer selection list.

In this case, the printing system is constructed at the hospital, so the keyword in the document only is described. However, it is still possible to construct the printing system at a place other than the hospital. In that case, it is possible to determine a printer automatically using selection information associating the information on the print settings and user information etc. with the printer.

An example of the selection information that uses the print setting information is selection information that associates a setting to perform color print with a printer that can perform color print. An example of the selection information that uses the user information is selection information that associates information indicating that the user is not an employee with a printer that users who are not an employee is allowed to use. Those cases are examples, and it is possible to use any other information as long as the selection information that can determine a printer automatically.

In addition, the rule information 47 includes association information that associates identification information for identifying each printer with terminal identification information for identifying a PC located near to each printer. In FIG. 5, printer names and IP addresses of the printers are used as the printer identification information, and PC names and IP addresses of the PCs are used as the PC identification information, and that information is associated with each other. In FIG. 5, the table is considered as a PC list. In this case, only apparatus names and IP addresses are used. However, cases are not limited to that, and other information such as Media Access Control (MAC) address etc. can be used.

With reference to FIG. 3 again, the dispatcher 42 determines a printer automatically to select a printer that the intermediate file 45 is transferred and is instructed to print. In this case, it is assumed that the printer 12 is selected. Subsequently, the dispatcher 42 transfers the intermediate file 45 to the real printer driver 43 corresponding to the selected printer 12.

The real printer driver 43 converts the intermediate file 45 into a print command that the printer 12 can interpret and transfers the intermediate file 45 to the printer 12. The printer 12 receives the print command transferred by the real printer driver 43 and executes printing based on the print command.

The dispatcher 42 refers to the rule information 47 to obtain information on the PC 15 located near to the printer 12 after selecting the printer 12 and before transferring the intermediate file 45 to the real printer driver 43. The information on the PC 15 is the PC name and IP address of the PC 15 shown in FIG. 5. Based on the obtained information on the PC 15, the dispatcher 42 transfers a confirmation message asking if it is OK to use the printer 12 to print to the PC 15.

As shown in FIG. 6, the confirmation message includes information “printer A5” for identifying the printer and a message “press OK key if there is no problem with printing”. In addition, the confirmation message includes the OK key and a cancel key to cancel printing. Consequently, after the nurse notices the confirmation message, the nurse can start printing by pressing the OK key if the nurse determines that there is no problem with printing. Otherwise, if there is some problem, the nurse can cancel printing by pressing the cancel button.

With reference to FIG. 3 again, if the nurse operates the PC 15 to press the OK key and the PC 10 accepts the response indicating that the OK key is pressed, the dispatcher 42 transfers the intermediate file to the real printer driver 43 described above.

A service program is implemented on the PCs 15 to 17 to receive the confirmation message transferred by the PC 10, display the confirmation message, and reply the response. The service program displays the OK key and the cancel key for the confirmation, detects that the OK key or the cancel key is pressed, and replies the response.

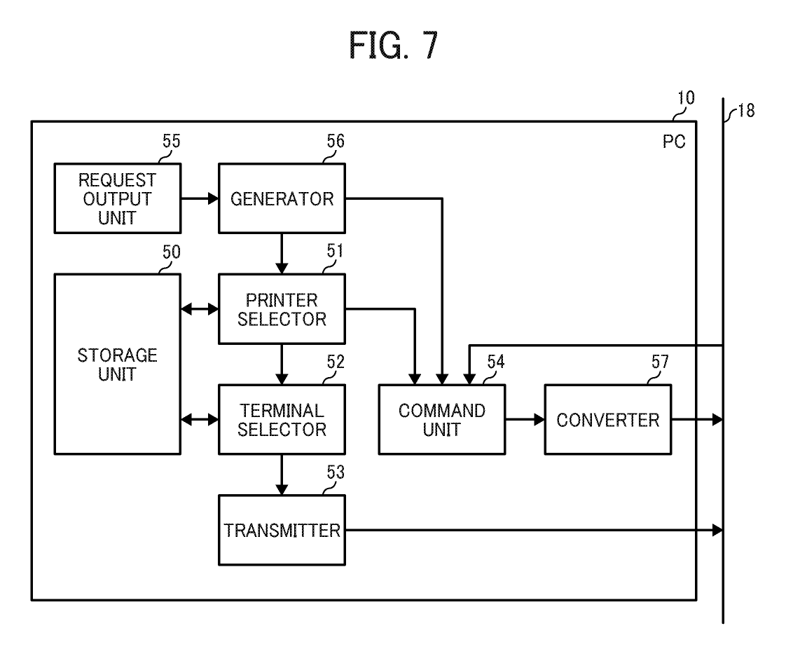

The hardware shown in FIG. 2 and the software shown in FIG. 3 function as functional units that perform operation described above, and it is possible to describe that the PC 10 includes these functional units. FIG. 7 is a diagram illustrating functional blocks included in the PC in this embodiment. The PC 10 consists of a storage unit 50, a printer selector 51, a terminal selector 52, a transmitter 53, and a command unit 54 at least. The PC 10 can include a request output unit 55, a generator 56, and a converter 57 in addition to those units.

The request output unit 55 outputs the document data to be printed and the print setting information along with a print command as the request for printing. The generator 56 accepts the information output by the request output unit, generates the intermediate file and the job information described above, and instructs the printer selector 51 to determine a printer. With reference to the selection information stored in the storage unit 50, the printer selector 51 determines a printer based on the intermediate file and the job information.

Based on the printer determined by the printer selector 51, the terminal selector 52 selects a PC to which the confirmation message is transferred with reference to the association information stored in the storage unit 50. The transmitter 53 transfers the confirmation message to the PC that the terminal selector 52 selects.

After receiving the response indicating that it is confirmed from the PC to which the confirmation message is transferred, the command unit 54 instructs the printer selected by the printer selector 51 to print. The converter 57 corresponding to the selected printer receives the command, and the converter 57 converts the intermediate file into the print command and transfers the print command to the printer. After receiving the print command, the printer interprets the print command, performs printing on paper, and outputs the paper.

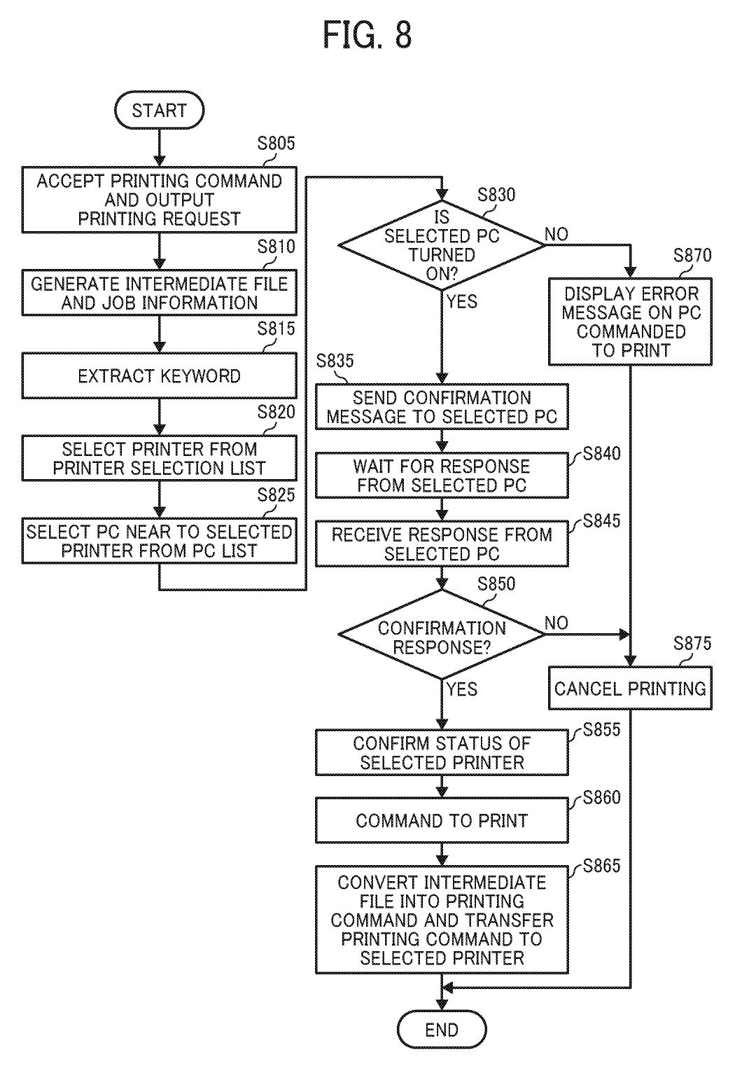

Operation performed by the PC 10 that includes the functional units described above is described below in detail with reference to the flowchart shown in FIG. 8. The physician who operates the PC 10 uses the application 40 to create the document to be printed, configures print settings, and instructs to print the document. After issuing the request, the process shown in FIG. 8 starts.

After receiving the request for printing by the physician, the request output unit 55 outputs the request for printing to the generator 56 in S805. In S810, the generator 56 generates image data from the document data, extracts print setting information etc., and generates the intermediate file consists of the image data and the extracted print setting information etc. In addition, the generator 56 generates the job information.

In S815, the printer selector 51 extracts a keyword as information for selecting the printer from the intermediate file. Subsequently, in S820, the printer is selected with reference to the printer selection list as the selection information stored in the storage unit 50. If the keyword is the patient ID, the patient ID is extracted, and a printer corresponding to the patient ID is selected as a destination printer using the extracted patient ID and the printer selection list.

In S825, the terminal selector 52 selects a PC located near to the selected printer from the PC list. In S830, the terminal selector 52 determines whether or not the selected PC is turned on. For example, it is possible to determine whether or not the selected PC is turned on by using ping command, transferring a packet to the selected PC, and checking whether or not there is a response from the PC. If the selected PC is turned on, the process proceeds to S835. If the selected PC is turned off, the process proceeds to S870.

In S835, the transmitter transfers the confirmation message to the selected PC. In S840, the command unit 54 waits for a response to the confirmation message transferred by the transmitter 53. In S845, the response transferred by pressing a key on the selected PC is received. In S850, it is determined whether or not the received response is the confirmation response. If the response is the confirmation response, the process proceeds to S855. Otherwise, i.e., if the response is the cancel response, the process proceeds to S875.

In S855, the printer selector 51 checks a status of the selected printer. Subsequently, in S860, the command unit 45 instructs the selected printer to print. Actually, printing is requested to the real printer driver 43 corresponding to the selected printer, i.e., the converter 57. In S865, the converter 57 converts the intermediate file into the print command, transfer the print command to the selected printer, and instructs the printer to print.

Communication between the PC 10 and the selected PC can be performed using an appropriate communication protocol such as TCP/IP etc. In addition, communication between the PC 10 and the selected printer can be performed using Management Information Base (MIB) information. The process shown in FIG. 8 ends after transferring the print command to the printer.

In S870, an error message is displayed on a displayed screen of the PC 10 that requested to print. To implement the operation, the PC 10 includes a display unit as the functional unit, and the command unit 54 can instruct the display unit to display the error message. In S875, if the selected PC is turned off or the cancel key is pressed while the selected PC is turned on, cancel operation that cancels printing is performed. In the cancel operation, the intermediate file and the job information etc. are deleted. After finishing the cancel operation, the process in FIG. 8 ends to finish the operation of the PC 10. To perform the cancel operation, the PC 10 can further include a cancel unit as the functional unit.

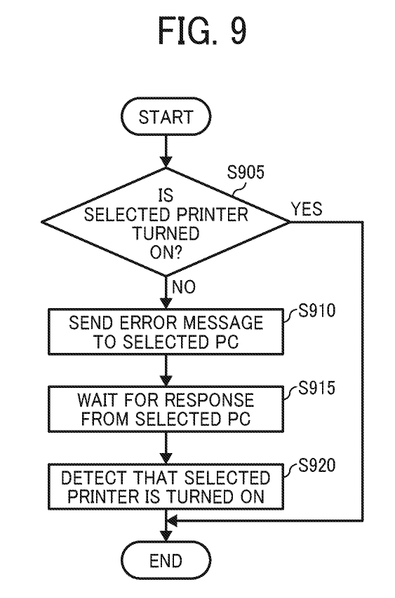

The operation of checking the status of the printer in S855 in FIG. 8 is described below in detail with reference to FIG. 9. After starting the process in FIG. 9, it is determined whether or not the selected printer is turned on in S905. Whether the printer is turned on can be checked just like checking whether or not the PC is turned on. If the printer is turned on, the process ends. Otherwise, if the printer is turned off, the process proceeds to S910.

In S910, the transmitter 53 transfers the error message to the PC selected in S825 in FIG. 8 to instruct the PC to display the error message on its displayed screen. In this case, it is also possible to display a message indicating that the printer located near to the PC is turned off. In S915, the command unit 54 waits for the response from the selected PC. In S920, a packet is transferred regularly using ping command etc. to detect if the printer is turned on. If it is detected that the printer is turned on, the process ends.

Regarding time of waiting for the response in S840 in FIG. 8 and S915 in FIG. 9, it is possible to wait until the response is received. Otherwise, it is possible to configure predetermined time preliminarily and perform the cancel operation automatically after the predetermined time elapses. Therefore, the storage unit 50 can store information on the time of waiting for the response, and the command unit 54 can instruct the cancel unit to perform the cancel operation after the time elapses. As a result, it is possible to proceed operation without waiting for the response indefinitely. In addition, since the operation is finished by performing the cancel operation, it is possible to reduce load on the PC 10.

It is also possible to send e-mail to predetermined communication terminals such as the PC, tablet device, smartphone, and cellphone etc. used by the nurse who works in the vicinity of the printer to notify that the message has arrived after the predetermined waiting time elapses. In that case, the command unit 54 transfers a command to the transmitter 53 to instruct the transmitter 53 to send e-mail. In that case, whatever content of the e-mail can be used as long as it is possible to notify that the confirmation message has arrived at the selected PC. For example, a message like “PC A5 has got message to confirm if it is OK to print using the printer A5” can be used.

After the predetermined waiting time elapses, it is possible to perform either cancel operation or mail transfer operation. It is possible to select which operation is performed preliminarily, the storage unit 50 can store the configured operation information, and the command unit 54 can instruct to perform either operation.

As described above, it is possible to prevent the printout from being left on the printer by sending the confirmation message and performing printing after receiving the confirmation response. In addition, since printing is performed just after the OK key is pressed, it is possible that other people browse the printout.

In some cases, it is possible to create an incorrect prescription and bar-code for identifying a patient etc. to be printed by mistake. For example, incorrect patient name or incorrect medicine name can be input by mistake. Therefore, it is preferable to double-check those documents by person other than the creator. However, in case of double-checking all documents, burden at medical workplaces increases. To cope with this issue, by double-checking required items only, increase of burden at medical workplaces can be minimized, and it is still possible to reduce human error.

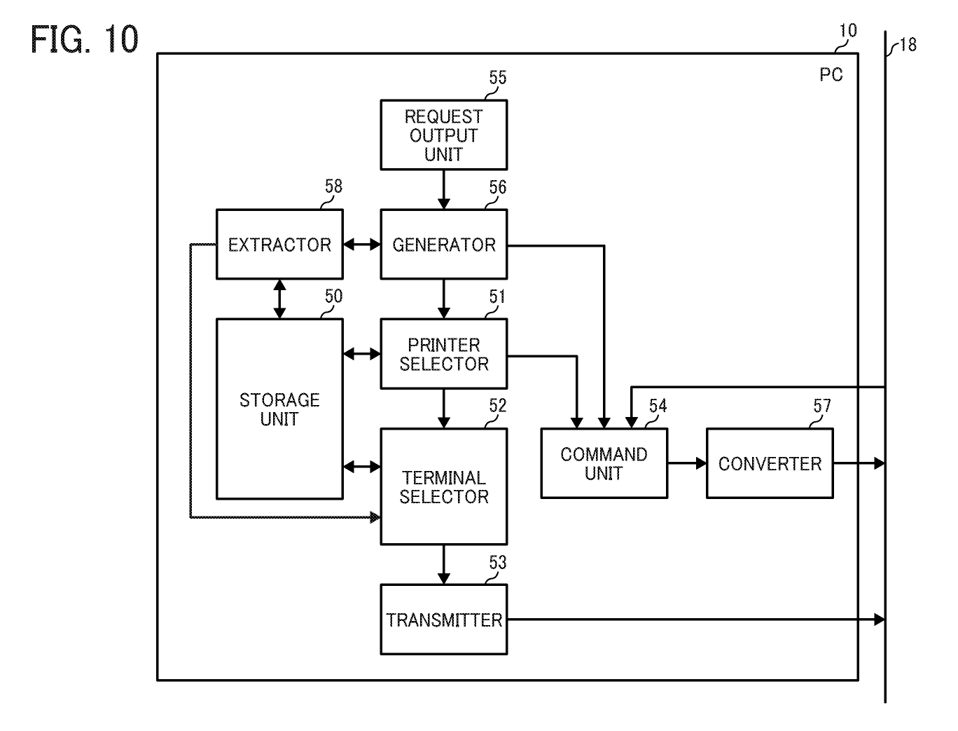

Consequently, the storage unit 50 further stores confirmation-needed information that specifies a string or image required to be confirmed and confirmation destination specified in accordance with a type of the string or image required to be confirmed. In addition, as shown in FIG. 10, an extractor 58 that refers to the confirmation-needed information stored in the storage unit 50 and extracts a keyword as the string or image specified by the confirmation needed information from the document commanded to be printed is further included.

Based on the keyword that the extractor 58 extracts, the transmitter 53 generates a message including the keyword (confirmation-needed message) and transfers the confirmation-needed message to the confirmation destination based on the information on the confirmation destination stored in the storage unit 50.

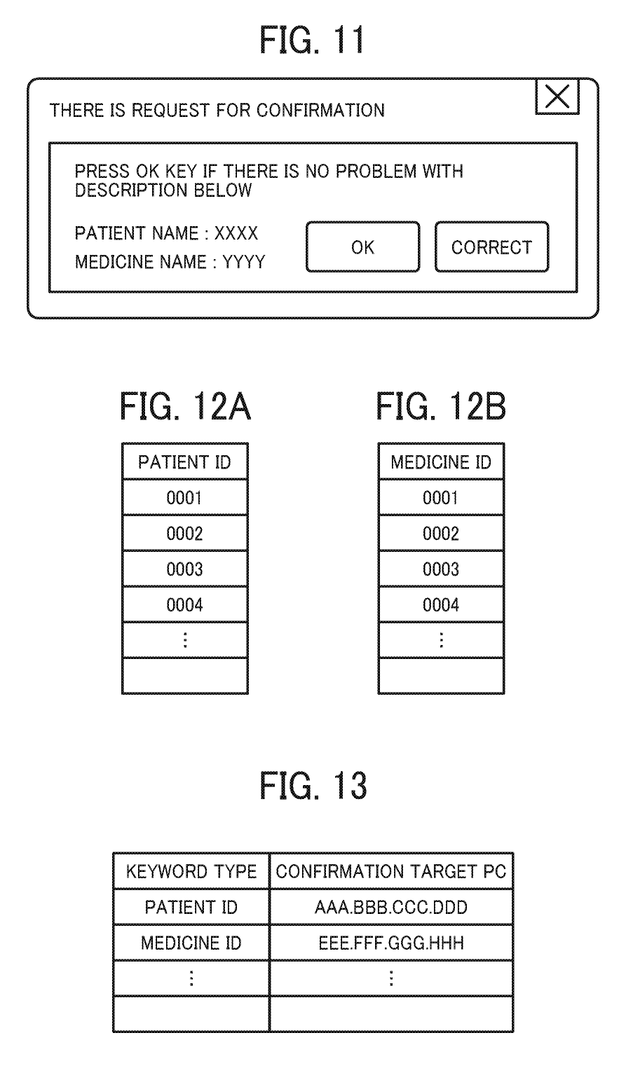

FIG. 11 is a diagram illustrating an example of the confirmation-needed message. In FIG. 11, the patient name and the medicine name are included as information required to be confirmed. In addition, the OK key and the Correct key is included, and it is possible to prompt to correct the information if the patient name or the medicine name is incorrect. An example of the confirmation destination is the PC used by the physician, nurse, or pharmaceutical chemist who are requested to confirm, and it is possible to confirm if the displayed patient name and medicine name are correct by pressing the OK key. By contrast, if the displayed patient name and medicine name are incorrect, it is possible to prompt the physician who requests to confirm to correct the information by pressing the Correct key. It should be noted that it is possible that the physician etc. who are requested to confirm inputs or selects a correct patient name or correct medicine name and sends back the corrected information.

With reference to FIG. 10 again, after the document is corrected by being double-checked by the physician who creates the document and the physician etc. who are requested to confirm, the printer is selected and printing is confirmed as described above, and the selected printer performs printing. By limiting the confirmation-needed information to the mistakable patient name and the medicine name, it is possible to minimize increase of burden at medical workplaces and reduce human error. In addition, by performing printing after conforming that it is OK to print, it is possible to prevent printouts from being left on the printer.

FIGS. 12A and 12B are diagrams illustrating a confirmation-needed list as the confirmation-needed information. In FIG. 12A, patient IDs of patients to be paid attention carefully and sound-alike patients easy to be mistaken are listed. In FIG. 12B, medicine IDs of medicines to be paid attention carefully and sound-alike medicines easy to be mistaken are listed.

An example of the confirmation destination is a confirmation destination list shown in FIG. 13 that information on PCs used by the double-checkers is listed associated with the patient IDs and the medicine IDs. Examples of the PC information are a PC address, a PC name, and MAC address etc. Examples of the double-checkers are other physicians, nurses, and pharmaceutical chemists. Other people can be the double-checker.

The double-checking can be performed between S810 and S815 in FIG. 8. That is because it is possible that the selected printer is changed if the patient name is corrected and the patient ID is modified.

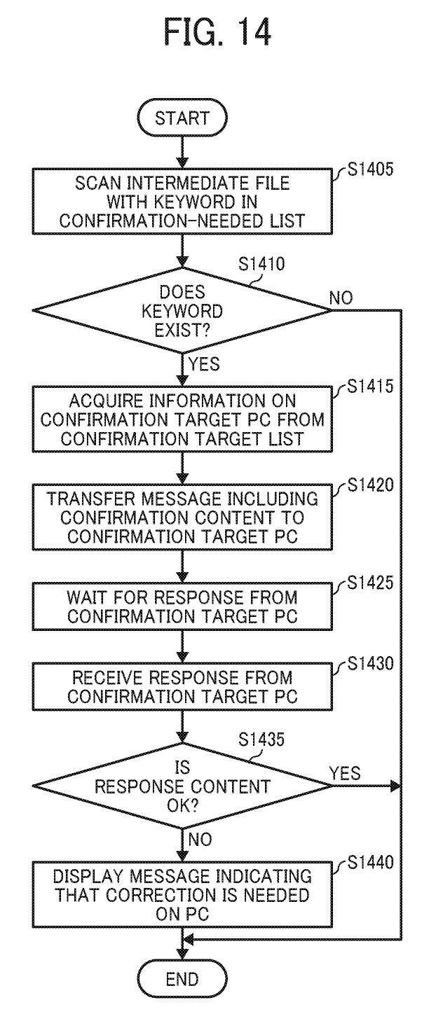

In FIG. 14, after starting the process, the extractor 58 searches through the intermediate file using the keyword in the confirmation-needed list. In S1410, the extractor 58 determines whether or not a word corresponding to the keyword exists after the search. If the word exists, the process proceeds to S1415. Otherwise, if the word does not exist, the process ends.

In S1415, information on the confirmation destination PC corresponding to the keyword extracted by the extractor 58 is obtained from the confirmation destination list. In S1420, the transmitter 53 generates the confirmation-needed message and transfers the message to the confirmation destination PC. In S1425, response from the confirmation destination PC is waited. In S1430, the response that the confirmation destination transfers after pressing the OK key or the cancel key is received.

In S1435, it is determined whether the received response is the confirmation or the correction. If the message is confirmed, the process ends. If the response is correction, the process proceeds to S1440, and a message that the correction is needed is displayed on the display screen of the PC 10. Subsequently, the process ends.

If it is determined that the word corresponding to the keyword does not exist or the response is the confirmation and the process ends, the printer is selected in S820 in FIG. 8. That is because it is unnecessary to correct the document. By contrast, if the message indicating that the correction is needed and the above process ends, the physician corrects the document and the process in FIG. 8 is started from the beginning. That is because the content of the document to be printed is modified and it is required to request printing again.

Regarding the keyword listed in the confirmation-needed list, it is possible to print the keyword in emphasized type after determining that the response is the confirmation in S1435. For example, it is possible to emphasize the keyword by changing font, printing the keyword in bold type, and enlarging the text size.

Since the operation of waiting for the response is included in the above process, as described before, it is possible to configure predetermined time preliminarily and perform the cancel operation automatically after the predetermined time elapses. Therefore, the storage unit 50 can store information on the time of waiting for the response in this case, and the command unit 54 can instruct the cancel unit to perform the cancel operation after the time elapses. As a result, it is possible to proceed operation without waiting for the response indefinitely. In addition, since the operation is finished by performing the cancel operation, it is possible to reduce load on the PC 10.

It is also possible to send e-mail to predetermined communication terminals such as the PC, tablet device, and smartphone etc. used by the nurse who works in the vicinity of the confirmation destination PC to notify that the message has arrived after the predetermined waiting time elapses. In that case, the command unit 54 transfers a command to the transmitter 53 to instruct the transmitter 53 to send e-mail. In that case, whatever content of the e-mail can be used as long as it is possible to notify that the message has arrived. For example, a message like “You have a request for confirmation” can be used.

Either cancel operation or mail transmission can be performed after the predetermined waiting time elapses, and it is possible to select whether the cancel operation or mail transmission is performed preliminarily. The storage unit can store information on the configured operation, and the command unit 54 can command to perform either operation. Otherwise, if the preset waiting time elapses, it is possible to modify the confirmation destination PC and send the confirmation-needed message to the modified confirmation destination PC. In this case, it is possible to register information on a first candidate PC and a second candidate PC in the PC list shown in FIG. 13, and it is possible to change the confirmation destination to the second candidate PC if there is no response from the first candidate PC after the predetermined time elapses. It should be noted that the number of the candidates is not limited to two, and it is possible to preset more than two candidates, i.e., a third candidate and a fourth candidate.

In the embodiment described above, the PC 10 includes all functional units shown in FIGS. 7 and 10. However, it is possible to implement those functional units distributing to multiple apparatuses. In that case, it is possible to provide the system as an information processing system.

In the above embodiment, the information processing apparatus, the information processing system, and the printing system are described. Numerous additional modifications and variations are possible in light of the above teachings. It is therefore to be understood that, within the scope of the appended claims, the disclosure of this patent specification may be practiced otherwise than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

Therefore, it is possible to provide a method executed by the information processing apparatus, information processing system, and printing system and a non-transitory recording medium storing a program that executes the information processing method. In addition, it is possible to provide an external apparatus such as a server apparatus that provides the program via a network.

The present invention also encompasses a non-transitory recording medium storing a program that executes an information processing method. The information processing method, performed by the information processing apparatus, includes the steps of storing, for each of multiple printers in a memory, selection information associating at least one of a specified string, a specified image, and job information of a print job with printer identification information for identifying the printer, the printer identification information of the printer being associated with terminal identification information for identifying an information processing terminal currently located near the printer, selecting, in response to a request for printing data, one of the multiple printers to print the requested data using the selection information stored in the memory, selecting an information processing apparatus associated with the selected printer, transferring the a confirmation message requesting to confirm that the selected printer prints the requested data to the selected information processing terminal, and instructing the selected printer to print the requested data in response to receiving a confirmation response from the selected information processing terminal.

In the above-described example embodiment, a computer can be used with a computer-readable program, described by object-oriented programming languages such as C++, C#, Java (registered trademark), or legacy programming languages such as machine language, assembler language, C language to control functional units used for the apparatus or system. The computer software can be provided to the programmable device using any storage medium or carrier medium for storing processor-readable code such as a floppy disk, a compact disk read only memory (CD-ROM), a digital versatile disk read only memory (DVD-ROM), DVD recording only/rewritable (DVD-R/RW), Blu-ray disc, electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these. A part of the functions of the described embodiments or all functions of the described embodiments may be implemented by one or more processing circuits. A processing circuit includes a programmed processor, as a processor includes circuitry. A processing circuit includes a programmable device (PD) such as a Field Programmable Gate Array (FPGA) for example. A processing circuit also includes devices such as an application specific integrated circuit (ASIC) and conventional circuit components arranged to perform the recited functions. It is also possible to distribute them storing a recording medium as data described in circuit configuration data (bit stream data) downloaded to the PD to implement the functional blocks on the PD, Hardware Description Language (HDL) for generating the circuit configuration data, Very High speed integrated circuits hardware Description Language (VHDL), and Verilog-HDL etc.

Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

What is claimed is:

1. An information processing apparatus, comprising:
a memory to store, for each of multiple printers, selection information associating at least one of a string, an image, and job information of a print job with printer identification information for identifying the printer, the printer identification information of the printer being associated with terminal identification information for identifying an information processing terminal currently located near the printer;
circuitry to select, in response to a request for printing data, one of the multiple printers to print the requested data using the selection information stored in the memory, and further select an information processing apparatus associated with the selected printer;
a transmitter to transfer the a confirmation message requesting to confirm that the selected printer prints the requested data to the selected information processing terminal,
wherein the circuitry instructs the selected printer to print the requested data in response to receiving a confirmation response from the selected information processing terminal.

2. The information processing apparatus according to claim 1, wherein the circuitry instructs the selected printer to cancel printing the data requested to be printed, in response to receiving a request for canceling printing from the selected information processing terminal in response to the confirmation message.

3. The information processing apparatus according to claim 2, wherein the circuitry instructs the selected printer to cancel printing the data requested to be printed in case of not receiving the confirmation response from the selected information processing terminal within a predetermined period of time.

4. The information processing apparatus according to claim 2, wherein the circuitry instructs the transmitter to send e-mail to a predetermined communication terminal reporting that the message is transferred to the selected information processing terminal in case of not receiving the confirmation response from the selected information processing terminal within a predetermined period of time.

5. The information processing apparatus according to claim 1, wherein the memory stores first processing information indicating whether canceling printing the data requested to be printed or sending e-mail to a predetermined communication terminal reporting that the message is transferred to the selected information processing terminal, and the circuitry instructs either to cancel printing or to send the e-mail in accordance with the first processing information in case of not receiving a confirmation response from the selected information processing terminal within a predetermined period of time.

6. The information processing apparatus according to claim 1, wherein the memory further stores confirmation-needed information specifying a string or an image needed to be confirmed and information indicating a confirmation destination previously determined in accordance with a type of the string or a type of the image needed to be confirmed in association with each other, and
the circuitry selects, when the string or the image needed to be confirmed is extracted from the data requested to be printed, a confirmation destination associated with the extracted string or the extracted image, and causes the transmitter to transfer a message including the extracted string or the extracted image to the selected confirmation destination.

7. The information processing apparatus according to claim 6, wherein the circuitry instructs to cancel printing the data requested to be printed in case of not receiving a confirmation response from the selected confirmation destination within a predetermined period of time.

8. The information processing apparatus according to claim 6, wherein the circuitry instructs the transmitter to send e-mail to a predetermined communication terminal reporting that the message including the string or the image is transferred to the selected information processing terminal in case of not receiving the confirmation response from the selected confirmation destination within a predetermined period of time.

9. The information processing apparatus according to claim 6, wherein the memory stores second processing information indicating whether canceling printing the data requested to be printed or sending e-mail to a predetermined communication terminal reporting that a message including the string or the image to the selected information processing terminal, and the circuitry instructs either to cancel printing or to send the e-mail in accordance with the second processing information in case of not receiving the confirmation response from the selected information processing terminal within a predetermined period of time.

10. A method of processing information, comprising:
storing, for each of multiple printers in a memory, selection information associating at least one of a specified string, a specified image, and job information of a print job with printer identification information for identifying the printer, the printer identification information of the printer being associated with terminal identification information for identifying an information processing terminal currently located near the printer;
selecting, in response to a request for printing data, one of the multiple printers to print the requested data using the selection information stored in the memory;
selecting an information processing apparatus associated with the selected printer;
transferring the a confirmation message requesting to confirm that the selected printer prints the requested data to the selected information processing terminal; and
instructing the selected printer to print the requested data in response to receiving a confirmation response from the selected information processing terminal.

11. The method of processing information according to claim 10, wherein the method further comprises:
instructing the selected printer to cancel printing the data requested to be printed, in response to receiving a request for canceling printing from the selected information processing terminal in response to the confirmation message.

12. The method of processing information according to claim 10, wherein the method further comprises:
instructing the selected printer to cancel printing the data requested to be printed in case of not receiving the confirmation response from the selected information processing terminal within a predetermined period of time.

13. The method of processing information according to claim 10, wherein the method further comprises:
instructing the transmitter to send e-mail to a predetermined communication terminal reporting that the message is transferred to the selected information processing terminal in case of not receiving the confirmation response from the selected information processing terminal within a predetermined period of time.

14. The method of processing information according to claim 10, wherein the method further comprises:
storing first processing information indicating whether canceling printing the data requested to be printed or sending e-mail to a predetermined communication terminal reporting that the message is transferred to the selected information processing terminal; and
instructing either to cancel printing or to send the e-mail in accordance with the first processing information in case of not receiving the confirmation response from the selected information processing terminal within a predetermined period of time.

15. The method of processing information according to claim 10, wherein the method further comprises:
storing confirmation-needed information specifying a string or an image needed to be confirmed and information indicating a confirmation destination previously determined in accordance with a type of the string or a type of the image needed to be confirmed in association with each other;
selecting, when the string or the image needed to be confirmed is extracted from the data requested to be printed, a confirmation destination associated with the extracted string or the extracted image; and
transferring a message including the extracted string or the extracted image to the selected confirmation destination.

16. The method of processing information according to claim 15, wherein the method further comprises:
instructing to cancel printing the data requested to be printed in case of not receiving a confirmation response from the selected confirmation destination within a predetermined period of time.

17. The method of processing information according to claim 15, wherein the method further comprises:
instructing to send e-mail to a predetermined communication terminal reporting that the message including the string or the image is transferred to the selected information processing terminal in case of not receiving the confirmation response from the selected confirmation destination within a predetermined period of time.

18. The method of processing information according to claim 15, wherein the method further comprises:
storing second processing information indicating whether canceling printing the data requested to be printed or sending e-mail to a predetermined communication terminal reporting that a message including the string or the image to the selected information processing terminal; and
instructing either to cancel printing or to send the e-mail in accordance with the second processing information in case of not receiving the confirmation response from the selected information processing terminal within a predetermined period of time.

19. An information processing system, comprising:
a storage unit to store, for each of multiple printers, selection information associating at least one of a string, an image, and job information of a print job with printer identification information for identifying the printer, the printer identification information of the printer being associated with terminal identification information for identifying an information processing terminal currently located near the printer;
a printer selector to select, in response to a request for printing data, one of the multiple printers to print the requested data using the selection information stored in the storage unit;
a terminal selector to select an information processing apparatus associated with the selected printer;
a transmitter to transfer the a confirmation message requesting to confirm that the selected printer prints the requested data to the selected information processing terminal; and
a command unit to instruct the selected printer to print the requested data in response to receiving a confirmation response from the selected information processing terminal.
